(19) United States
(12) Patent Application Publication
(10) Pub. No.: US 2017/0264682 A1
(43) Pub. Date: Sep. 14, 2017

(54) DATA MOVEMENT AMONG DISTRIBUTED DATA CENTERS

(71) Applicant: EMC IP Holding Company LLC, Hopkinton, MA (US)

(72) Inventors: William N. Eagle, Oxford, MA (US); Cao Yu, Beijing (CN); Li Sanping, Beijing (CN); Dong Zhe, Beijing (CN); Tao Jun, Shanghai (CN)

(21) Appl. No.: 15/454,060

(22) Filed: Mar. 9, 2017

(30) Foreign Application Priority Data
Mar. 9, 2016 (CN) CN201610134634.5

(51) Int. Cl. H04L 29/08

(52) U.S. Cl. CPC H04L 67/1078; H04L 67/1097; H04L 67/06

(57) ABSTRACT

Embodiments of the present disclosure provide a method and an apparatus for data movement among distributed data centers in a peer network. The method comprises: reducing an amount of data to be moved by pre-processing the data; generating a torrent file for the data; distributing the torrent file to a peer data center, and in response to receiving a data request from the peer data center, transmitting a segment of the data to the peer data center. Compared with the prior art, the embodiments of the present disclosure can realize reliable and fast data movement among distributed data centers over an unreliable and low-bandwidth network, can support an adaptive network topology among distributed data centers without complex pre-configuration or cumbersome runtime coordination, can support different types of data storage, and facilitates coordinated cloud computing and data aggregation among distributed data centers.

### RELATED APPLICATIONS

This application claim priority from Chinese Patent Application Number CN201610134634.5, filed on Mar. 9, 2016 at the State Intellectual Property Office, China, titled “DATA MOVEMENT AMONG DISTRIBUTED DATA CENTERS” the contents of which is herein incorporated by reference in its entirety.

### FIELD

Embodiments of the present disclosure generally relate to data movement, and more specifically relate to a method and apparatus for data movement among distributed data centers.

### BACKGROUND

The concepts of cloud computing and a third platform have been rapidly accepted worldwide. Many enterprises have migrated their infrastructure or services to third platforms. These services are supported by large data centers, while such data centers are always geographically distributed. Therefore, an efficient and reliable data movement mechanism between these geographically distributed data centers is essential for providing high data mobility and availability, as well as a predictable data service level. Data movement between geographically distributed data centers faces the following challenges: firstly, the data amount to be distributed can be tremendous; secondly, network connection between these data centers can have a limited bandwidth and is unstable; thirdly, the data to be distributed possibly have various types, e.g., a file, a data block, and/or an object, etc.

However, conventional solutions cannot solve these problems well. First, data distribution tools of many conventional data centers require a 1:1:1 mapping topology when moving data among a plurality of data centers. If the number of data centers is more than 5, the topology configuration will become very complex. However, data centers on third platforms require a flexible data movement mechanism, where the topology of the network connection between data centers is adaptive, such that the data center can dynamically join or leave the network, with no requirement for complex pre-configuration or cumbersome runtime coordination. Secondly, the conventional data movement solutions can only work for data centers whose in-between distances are at Metro or National Levels. Due to unstable and low-bandwidth network connections, the conventional data movement solutions cannot be utilized for reliable and efficient data movement at the global level. Thirdly, the conventional data movement and synchronization tools for data centers usually can only support block-based storage. The data synchronization tools for upper applications built on data centers are usually file-based. However, there are usually three types of data storage: file-based, block-based, and object-based. The conventional solutions lack a function and mechanism of moving data between different types of storage devices. Fourthly, the conventional technical solutions usually do not support a plurality of servers across different data centers to collaborate on extremely large-scale data computing.

Therefore, a more efficient and reliable data movement solution is needed in the art to solve the problems above.

### SUMMARY

Objectives of embodiments of the present disclosure intend to provide a method and apparatus for data movement among distributed data centers so as to solve the problems above.

According to a first aspect of the present disclosure, there is provided a method for data movement among distributed data centers in a peer network, comprising: reducing an amount of data to be moved by pre-processing the data; generating a torrent file for the data; distributing the torrent file to a peer data center, and in response to receiving a data request from the peer data center, transmitting a segment of the data to the peer data center.

In some embodiments, the pre-processing the data comprises: de-duplicating and compressing the data.

In some embodiments, the generating a torrent file for the data comprises: segmenting the data into a plurality of segments of an equal length, the segment being included in the plurality of segments; determining a hash value for the segment; and writing an index and the hash value for the segment into the torrent file.

In some embodiments, the torrent file includes configuration information related to the data, and the generating a torrent file for the data comprises: generating the configuration information related to the data; and writing the configuration information into the torrent file.

In some embodiments, the generating the configuration information related to the data comprises: determining one or more candidates for the configuration information; determining a cost for each of the one or more candidates; and selecting, from the one or more candidates, a candidate with the lowest cost as the configuration information related to the data.

In some embodiments, the distributing the torrent file to a peer data center comprises: distributing the torrent file to the peer data center via a torrent server with a reliable network protocol.

In some embodiments, the data includes a file, and the transmitting a segment of the data to the peer data center comprises: segmenting the file into a plurality of segments of an equal length, the segment being included in the plurality of segments; and transmitting the segment of the file to the peer data center.

In some embodiments, the data includes a data block, and the transmitting a segment of the data to the peer data center comprises: transmitting the data block to the peer data center.

In some embodiments, the data includes an object, and the transmitting a segment of the data to the peer data center comprises: transmitting the object to the peer data center.

According to a second aspect of the present disclosure, there is provided a method for data movement among distributed data centers in a peer network, comprising: receiving a torrent file from a source data center; transmitting a first data request for a segment of data associated with the torrent file to a first peer data center connected to the source data center, receiving the segment of the data from the first peer data center; and in response to receiving a plurality of segments of the data, combining the plurality of segments into the data, the segment being included in the plurality of segments.

In some embodiments, the receiving a torrent file from a source data center comprises: receiving the torrent file from the source data center via a torrent server with a reliable network protocol.

In some embodiments, the first peer data center includes the source data center.

In some embodiments, the torrent file includes configuration information related to the data, and the transmitting a first data request comprises: transmitting the first data request for the data to the first peer data center based on the configuration information.

In some embodiments, the receiving the segment of the data from the first peer data center comprises: in response to receiving the segment of the data, determining a first hash value of the segment; comparing a first hash value with a second hash value corresponding to the segment, the second hash value being included in the torrent file; saving the segment in response to the first hash value being equal to the second hash value; and transmitting a second data request for the segment to a second peer data center in response to the first hash value being unequal to the second hash value.

In some embodiments, the data includes a file, and the receiving the segment of the data from the first peer data center comprises: receiving the segment of the file from the first peer data center.

In some embodiments, the combining the plurality of segments into the data comprises: in response to receiving a plurality of segments of the file, obtaining the file by sequentially concatenating the plurality of segments of the file.

In some embodiments, the data includes a first data block, and the receiving the segment of the data from the first peer data center comprises: receiving the first data block from the first peer data center.

In some embodiments, the combining the plurality of segments into the data comprises: in response to receiving the first data block, writing content of the first data block back into a second data block corresponding to the first data block.

In some embodiments, the data includes an object, and the receiving the segment of the data from the first peer data center comprises: receiving the object from the first peer data center.

In some embodiments, the method further comprises: in response to disconnection from the first peer data center, establishing a connection with a third peer data center so as to transmit a third data request for the data to the third peer data center.

In some embodiments, the method further comprises: in response to a fourth data request from a fourth peer data center, transmitting the segment of the data to the fourth peer data center.

According to a third aspect of the present disclosure, there is provided an apparatus for data movement among distributed data centers in a peer network, comprising: a pre-processing module configured to reduce an amount of data to be moved by pre-processing the data; a torrent file generating module configured to generate a torrent file for the data; a torrent file distributing module configured to distribute the torrent file to a peer data center; and a first data transmitting module configured to, in response to receiving a data request from the peer data center, transmit a segment of the data to the peer data center.

In some embodiments, the pre-processing module is further configured to: de-duplicate and compress the data.

In some embodiments, the torrent file generating module is further configured to: segment the data into a plurality of segments of an equal length, the segment being included in the plurality of segments; determine a hash value for the segment; and write an index and the hash value for the segment into the torrent file.

In some embodiments, the torrent file includes configuration information related to the data, and the torrent file generating module is further configured to: generate the configuration information related to the data; and write the configuration information into the torrent file.

In some embodiments, the generating the configuration information related to the data comprises: determining one or more candidates for the configuration information; determining a cost for each of the one or more candidates; and selecting, from the one or more candidates, a candidate with the lowest cost as the configuration information related to the data.

In some embodiments, the torrent file distributing module is further configured to: distribute the torrent file to the peer data center via a torrent server with a reliable network protocol.

In some embodiments, the data includes a file, and the first data transmitting module is further configured to: segment the file into a plurality of segments of an equal length, the segment being included in the plurality of segments; and transmit the segment of the file to the peer data center.

In some embodiments, the data includes a data block, and the first data transmitting module is further configured to: transmit the data block to the peer data center.

In some embodiments, the data includes an object, and the first data transmitting module is further configured to: transmit the object to the peer data center.

According to a fourth aspect of the present disclosure, there is provided an apparatus for data movement among distributed data centers in a peer network, comprising: a torrent file receiving module configured to receive a torrent file from a source data center, a request transmitting module configured to transmit a first data request for a segment of data associated with the torrent file to a first peer data center connected to the source data center; a data receiving module configured to receive the segment of the data from the first peer data center, and a data combining module configured to, in response to receiving a plurality of segments of the data, combine the plurality of segments into the data, the segment being included in the plurality of segments.

In some embodiments, the data receiving module is further configured to: receive the torrent file from the source data center via a torrent server with a reliable network protocol.

In some embodiments, the first peer data center includes the source data center.

In some embodiments, the torrent file includes configuration information related to the data, and the request transmitting module is further configured to: transmit the first data request for the data to the first peer data center based on the configuration information.

In some embodiments, the data receiving module is further configured to: in response to receiving the segment of the data, determine a first hash value of the segment; compare a first hash value with a second hash value corresponding to the segment, the second hash value being included in the torrent file; save the segment in response to the first hash value being equal to the second hash value; and transmit a second data request for the segment to a second peer data center in response to the first hash value being unequal to the second hash value.

In some embodiments, the data includes a file, and the data receiving module is further configured to: receive the segment of the file from the first peer data center.

In some embodiments, the data combining module is further configured to: in response to receiving a plurality of segments of the file, obtain the file by sequentially concatenating the plurality of segments of the file.

In some embodiments, the data includes a first data block, and the data receiving module is further configured to: receive the data block from the first peer data center.

In some embodiments, the data combining module is further configured to: in response to receiving the first data block, write content of the first data block back into a second data block corresponding to the first data block.

In some embodiments, the data includes an object, and the data receiving module is further configured to: receive the object from the first peer data center.

In some embodiments, the apparatus further comprises: a network connection module configured to, in response to disconnection from the first peer data center, establish a connection with a third peer data center so as to transmit a third data request for the data to the third peer data center.

In some embodiments, the apparatus further comprises: a second data transmitting module configured to, in response to a fourth data request from a fourth peer data center, transmit the segment of the data to the fourth peer data center.

According to a fifth aspect of the present disclosure, there is provided a computer program product for data processing, the computer program product being tangibly stored on a non-transient computer readable medium and comprising machine-executable instructions, the machine-executable instructions, when being executed, causing a machine to execute any method step in the methods.

Compared with the prior art, the embodiments of the present disclosure can realize reliable and fast data movement among distributed data centers over an unreliable and low-bandwidth network, can support an adaptive network topology among distributed data centers without complex pre-configuration or cumbersome runtime coordination, can support different types of data storage, and facilitates coordinated cloud computing and data aggregation among distributed data centers.

### BRIEF DESCRIPTION OF THE DRAWINGS

The above and other objectives, features and advantages of the embodiments of the present disclosure will become easily understood by reading the detailed depiction below with reference to the accompanying drawings. Several embodiments of the present disclosure are illustrated in an exemplary, but not limitative, manner in the drawings, in which:

FIG. 1 illustrates a schematic diagram of an environment 100 for data movement among distributed data centers according to embodiments of the present disclosure;

FIG. 2 illustrates a flowchart of a method 200 for data movement among distributed data centers according to embodiments of the present disclosure;

FIG. 3 illustrates a flowchart of a method 300 for generating configuration information related to data to be moved in a cost-based manner according to embodiments of the present disclosure;

FIG. 4 illustrates a flowchart of a method 400 for data movement among distributed data centers according to embodiments of the present disclosure;

FIG. 5 illustrates a schematic diagram of data movement with respect to data being modified during a moving process according to embodiments of the present disclosure;

FIG. 6 illustrates a schematic diagram of coordinated cloud computing among distributed data centers according to embodiments of the present disclosure;

FIG. 7 illustrates a block diagram of an apparatus 700 for data movement among distributed data centers according to embodiments of the present disclosure;

FIG. 8 illustrates a block diagram of an apparatus 800 for data movement among distributed data centers according to embodiments of the present disclosure;

FIG. 9 illustrates a schematic block diagram of a device 900 adapted to implement the embodiments of the present disclosure.

Throughout the drawings, the same or corresponding reference numerals represent the same or corresponding parts.

### DETAILED DESCRIPTION OF THE EMBODIMENTS

Hereinafter, various exemplary embodiments of the present disclosure will be described in detail with reference to the accompanying drawings. It should be noted that these drawings and depictions only serve as exemplary embodiments. It should be pointed out that alternative embodiments of the structures and methods disclosed here are easily envisaged according to the subsequent description and may be used without departing from the principle as sought to be protected by the present disclosure.

It should be understood that these exemplary embodiments are provided only to enable those skilled in the art to better understand and then further implement the present disclosure, not for limiting the scope of the present disclosure in any manner.

The terms “comprise,” “include” and similar terms used here should be understood as open terms, i.e., “comprising/including, but not limited to.” The term “based on” refers to “at least partially based on.” The term “one embodiment” indicates “at least one embodiment”; the term “another embodiment” indicates “at least one further embodiments.” Relevant definitions of other terms will be provided in the description below.

Hereinafter, a technical solution of determining a physical position of a device according to the embodiments of the present disclosure will be described in detail with reference to the accompanying drawings.

As mentioned above, in order to implement reliable and fast data movement among distributed data centers, embodiments of the present disclosure provide a scheme of peer-to-peer (P2P) data movement. This scheme may be used to build a global virtual data center so as to share and reposition data transparently in a worldwide scope.

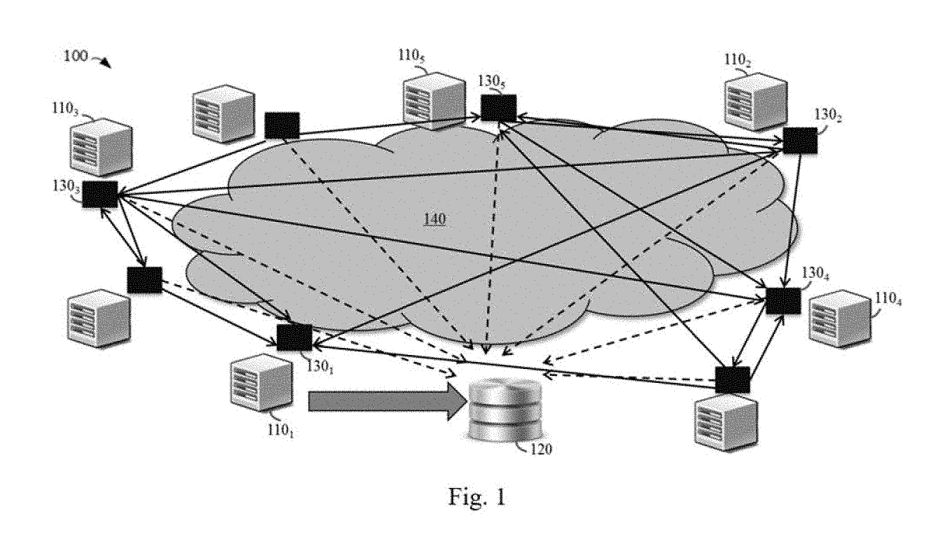

FIG. 1 shows a schematic diagram of an environment 100 for performing data movement among distributed data centers according to the embodiments of the present disclosure. FIG. 1 illustrates a plurality of data centers 110₁, 110₂ . . . 110ₙ that are remote from one another and connected via an unstable network 140 with limited bandwidth, where, for example, the data center 110₁ intends to move data to another data center (hereinafter, the data center 110₁ is also referred to as “a source data center”). In some embodiments of the present disclosure, in order to establish a peer network for data movement among the plurality of data centers 110₁, 110₂, . . . , 110ₙ, a central torrent server may be first established. For example, FIG. 1 illustrates the established torrent server 120 for hosting a torrent file and exchanging data among all data centers (i.e., data centers 110₁, 110₂, . . . , 110ₙ). The torrent file stored in the torrent server 120 may include metadata of all of the data centers and data to be move, such as an address of a data center and description and checksum of each data segment. Secondly, for each of the data center (i.e., each of the data centers 110₁, 110₂, . . . , 110ₙ), a corresponding P2P proxy may be established. For example, FIG. 1 illustrates a plurality of P2P proxies 130₁, 130₂, . . . , 130ₙ, which are associated with the data centers, respectively. Each of the data centers will establish a P2P network with other data centers via its P2P proxy. The P2P proxy may be used to communicate with other P2P proxies and the torrent server so as to transmit and receive data between a main data center associated with the P2P proxy and other remote data centers. The P2P proxy may be implemented as a pluggable physical device in the data center or a software application running in the data center. In this way, each of the data centers has a respective P2P proxy that performs data exchange and movement with the P2P protocol, such that a P2P network can be established among all data centers.

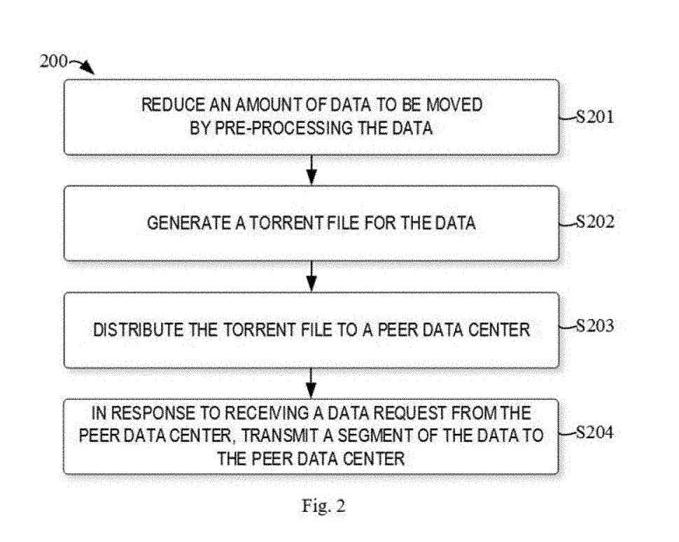

FIG. 2 illustrates a flowchart of a method 200 for data movement among distributed data centers according to embodiments of the present disclosure. Hereinafter, the method 200 will be described in detail with reference to FIG. 1. For example, the method 200 may be carried out by the data center 110₁ (i.e., the source data center) shown in FIG. 1 which intends to move data to another data center. More specifically, the method 200 may be carried out by P2P proxy 130₁ of the data center 110₁. The method 200 may comprise steps S201 to S204.

At S201, pre-processing is performed on data to be moved so as to reduce an amount of the data. In some embodiments of the present disclosure, for example, the data center 110₁ (e.g., its P2P proxy 130₁) may perform de-duplication and compression to the data to be move so as to reduce the amount of the data to be moved.

The method 200 proceeds to S202. At S202, a torrent file is generated for the data. In some embodiments of the present disclosure, the torrent file for the data may be generated by the data center 110₁ (e.g., its P2P proxy 130₁). For example, a process of generating a seed file may comprise: segmenting the data into a plurality of segments of an equal length; determining a hash value for each of the plurality of segments; and writing an index and a hash value of the segment into the torrent file.

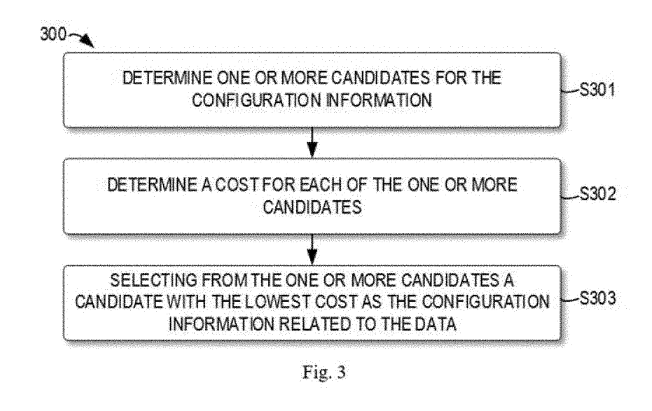

In some embodiments, the torrent file may also comprise configuration information associated with the data to be moved. The configuration information may include information associated with data placement and relocation, such as how to place the data to be moved into a plurality of remote data centers so as to achieve an optimal performance (e.g., high availability (HA) and a Service Level Agreement (SLA), etc.). In some embodiments of the present disclosure, for example, the configuration information associated with the data may be generated by the data center 110₁ (e.g., its P2P proxy 130₁) which may also write the configuration information into the torrent file. Additionally or alternatively, the configuration information associated with the data to be moved may be generated in a cost-based manner. For example, FIG. 3 illustrates a flowchart of a method 300 for generating the configuration information associated with the data to be moved in a cost-based manner according to embodiments of the present disclosure. As illustrated in FIG. 3, the method 300 may comprise steps S301-S303. At S301, one or more candidates for the configuration information are determined. In some embodiments of the present disclosure, the following factors may be considered when placing and relocating the data: a storage device capacity, HA, access performance (e.g., data access delay), where the data is located, and fault tolerance, etc. The method 300 proceeds to S302 to determine a cost for each of the one or more candidates. For example, a cost score may be computed for each of factors as listed above, and a total cost for each of the one or more candidates may be computed by summing up all of the cost scores. A lower total cost may indicate that the data placement scheme included in the configuration information is more preferable. The method 300 then proceeds to S303 to select from the one or more candidates a candidate with the lowest cost as the configuration information related to the data. Therefore, the configuration information may include an optimal placement scheme associated with the data. The selected configuration information may be placed into the torrent file so as to be distributed to all of the data centers. When a peer data center obtains the torrent file, the peer data center may obtain the configuration information (e.g., a placement scheme including the data) associated with the data to be moved, such that the data may be obtained accordingly based on the configuration information. When the configuration information is to be changed (e.g., to change the data placement scheme included therein), the torrent file that includes the configuration information may be modified. In this way, other dace centers may correspondingly adjust and exchange their data according to the modified torrent file. Accordingly, compared with traditional schemes, the embodiments of the present disclosure can achieve dynamic and intelligent data placement and relocation.

Return to FIG. 2. The method 200 proceeds to step S203. At S203, the torrent file is distributed to a peer data center. In some embodiments of the present disclosure, the data center 110₁ (e.g., its P2P proxy 130₁) may distribute the torrent file to one or more peer data centers (e.g., the data centers 110₂, 110₃, 110ₙ) with a reliable network protocol (e.g., Transfer Control Protocol (TCP)). Additionally or alternatively, the data center 110₁ (e.g., its P2P proxy 130₁) may first upload the torrent file to the torrent server 120; then the data centers 110₂, 110₃, . . . , 110ₙ (e.g., their corresponding P2P proxies 130₂, 130₃, . . . , 130ₙ) may request the torrent server 120 to obtain the torrent file. After the one or more peer data centers obtain the torrent file, they may request all accessible data centers (e.g., including, but not limited to, the data center 110₁) in the P2P network to obtain segments of the data.

The method 200 proceeds to step S204. At S204, in response to receiving the data request from the peer data center, the segment of the data is transmitted to the peer data center.

In some embodiments of the present disclosure, the data to be moved may comprise at least three types: file-based data, data block-based data, and object-based data. When the data to be moved is a file, the file may be segmented into a plurality of segments of equal length and each of the segments is regarded as a basic unit for data transmission. When the data to be moved is a data block, each data block may be regarded as a basic unit for data transmission. When the data to be moved is an object, each object may be regarded as a basic unit for data transmission, or for example, for a larger object, the object may be segmented into a plurality of segments of equal length and each of the segments of the object may be regarded as a basic unit for data transmission. In this way, the embodiments of the present disclosure can support data storage of different types.

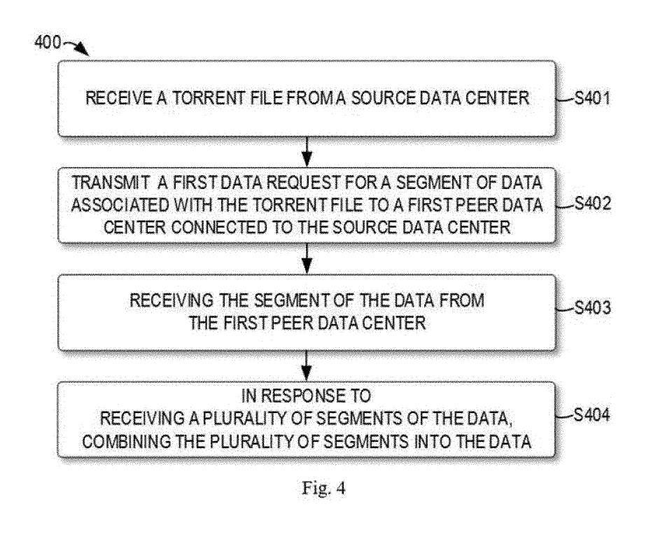

FIG. 4 illustrates a flowchart of a method 400 for data movement among distributed data centers according to embodiments of the present disclosure. Hereinafter, FIG. 1 may be referenced to describe the method 400 in detail. For example, the method 400 may be carried out by one or more peer data centers of a data center 110₁ (e.g., data center 110₂) as shown in FIG. 1 which intends to move data to other data centers. More specifically, for example, the method 400 may be carried out by the P2P proxy 130₂ of the data center 110₂. The method 400 may comprise steps S401-S404.

As mentioned above, the data center 110₁ may distribute a torrent file (S203 of FIG. 2) of the data to be moved via a torrent server 120 to a peer data center (e.g., data center 110₂). At S401, the data center 110₂ (e.g., its P2P proxy 130₂) may receive the torrent file from the source data center (i.e., the data center 110). In some embodiments of the present disclosure, the data center 110₂ (e.g., its P2P proxy 130₂) may receive the torrent file from the source data center via the torrent server 120 with a reliable network protocol (e.g., TCP).

The method 400 proceeds to step S402. At S402, based on the torrent file, a data request for a segment of data associated with the torrent file is transmitted to a peer data center that have established a connection with the source data center. For example, the data center 110₂ (e.g., its P2P proxy 130₂) may transmit a data request to the data centers 110₁, 110₅ (e.g., their corresponding P2P proxies 130₁, 130₄) which have established connections with the data center 110₂, so as to obtain one or more segments of the data associated with the torrent file. In some embodiments of the present disclosure, the torrent file may include configuration information associated with data to be moved, where the configuration information may include information associated with data placement and relocation, such as how to place the data to be moved into a plurality of remote data centers to achieve an optimal performance (e.g., a high availability (HA) and a Service Level Protocol (SLA), etc.). When the data center 110₂ obtains the torrent file, the data center 110₂ may obtain the configuration information (for example, including a placement scheme of the data) associated with the data to be moved from the torrent file, such that a data request for corresponding data may be transmitted based on the configuration information. For example, if the configuration information indicates that the data should be placed into one or more data centers including the data center 110₂, the data center 110₂ may transmit a data request for the corresponding data; while if the configuration information does not indicate that the data should be placed in the data center 110₂, the data center 110₂ may not transmit the data request for the corresponding data.

The method 400 proceeds to S403. At S403, the segment of the data is received from the peer data center. For example, in response to the configuration information included in the torrent file indicating that the data should be placed in the data center 110₂ (e.g., its P2P proxy 130₂), a data request may be transmitted to data centers 110₁, 110₄ and so on (e.g., their corresponding P2P proxies 130₁, 130₄, etc.) that have established connections with the data center 110₂, and one or more segments of the data are received from the data centers 110₁, 110₄ and so on. In some embodiments of the present disclosure, the data center 110₂ may verify the received one or more segments according to the torrent file. For example, step S403 may also comprise: in response to receiving the segment of the data, determining a first hash value of the segment; comparing the first hash value with a second hash value corresponding to the segment, the second hash value being included in the torrent file; in response to the first hash value being equal to the second hash value, saving the segment; in response to the first hash value being unequal to the second hash value, transmitting a data request to one or more peer data centers to re-obtain the segment.

Additionally, according to the principle of P2P network, besides receiving one or more segments of the data from one or more peer data centers, in response to a data request from a further peer data center (e.g., data center 110₃), the data center 110₂ may also transmit the one or more segments of the data to the further peer data center.

The method 400 proceeds to step S404. At S404, in response to receiving a plurality of segments of the data, the plurality of segments are combined into the data. For example, after the P2P proxy 130₂ of the data center 110₂ receives all of the segments of the data, the P2P proxy 130₂ may re-combine all of the segments of the data into the original data according to the torrent file.

In some embodiments of the present disclosure, the data received by the data center may include at least three types: file-based data, data block-based data, and object-based data. When the received data is file-based data, the file may have been segmented into a plurality of segments of an equal length in the source data center and each of the segments is regarded as a basic unit for data transmission. Therefore, in response to receiving all of the segments of the file, all of the segments may be sequentially concatenated to obtain the original file. When the received data is a data block, the data block may be regarded as a basic unit for data transmission. Therefore, in response to receiving the data block, content of the data block may be written back to a corresponding data block. When the received data is object-based data, for example, for a larger object, the object may have been segmented into a plurality of segments of equal length by the source data center and each of the segments of the object may be regarded as a basic unit for data transmission. Therefore, in response to receiving all of the segments of the object, all of the segments may be re-combined into the original object. In this way, embodiments of the present disclosure can support data storage of different types.

Because network connections between different data centers might be intermittent or unstable, the connection between two data centers might be lost at any time. For example, as shown in FIG. 2, the data connection between data centers 110₂ and 110₄ might be lost. At this point, the data center 110₂ may establish a connection with another data center (e.g., data center 110₅) so as to request data from the data center 110₅. In this way, any connection loss only has little impact on the overall data movement, such that the data can be fast broadcast to reduce the overall time of data movement.

In a practical scenario, the data to be moved might be modified during the movement process. The embodiments of the present disclosure can provide a solution for the data being modified during the movement process.

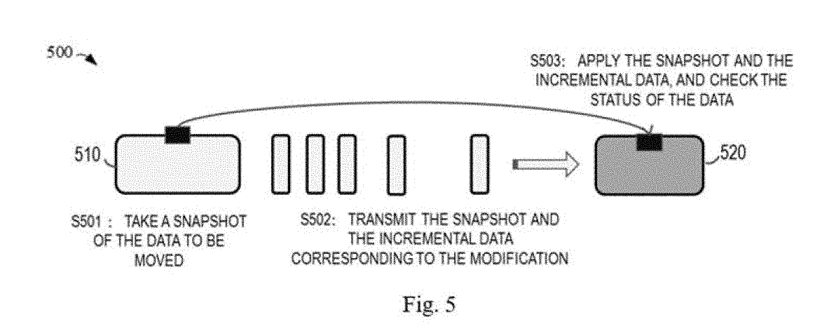

FIG. 5 illustrates a schematic diagram of data movement with respect to data being modified during a moving process according to embodiments of the present disclosure. For example, FIG. 5 illustrates data movement from a source data center 510 to a target data center 520, where the data to be moved will be modified during the process of data movement. As illustrated in FIG. 5, before starting the data movement, the source data center 510 may take (S501) a snapshot of the data to be moved. The snapshot may be transmitted using the method 200 with reference to FIG. 2. Meanwhile, the source data center 510 may monitor a change to the data. If modification of the data happens, the source data center 510 may generate incremental data corresponding to the modification and transmit (S502) the incremental data using the method 200 with reference to FIG. 2. During the whole process of the data movement, the source data center may continuously perform the above actions. On the other hand, when the target data center 520 receives the data, the target data center 520 may first apply the snapshot of the data to its local storage, and then apply each incremental data accordingly in a correct sequence. Additionally, the target data center 520 may check a storage status of the data at a fixed time interval (e.g., one hour or one day) so as to be able to recover the previous data from failure (S503).

In practical scenarios, the embodiments of the present disclosure may also implement coordinated cloud computation among distributed data centers.

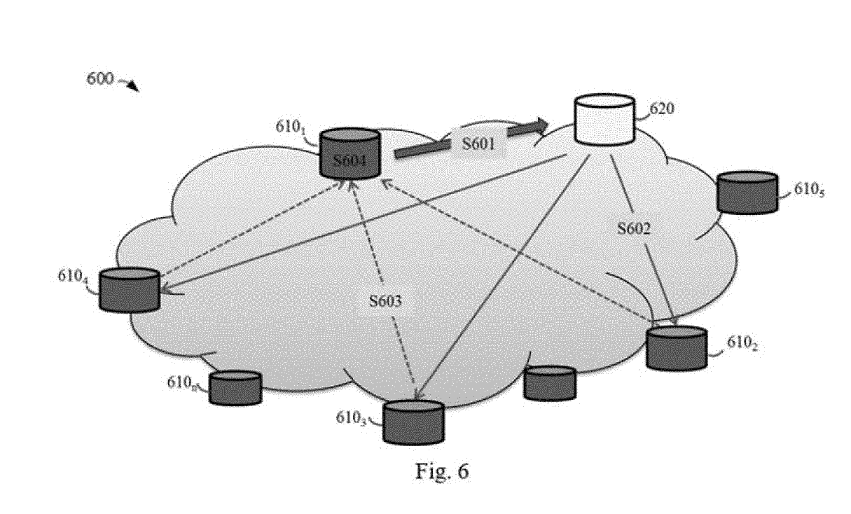

FIG. 6 illustrates a schematic diagram of coordinated cloud computing among distributed data centers according to embodiments of the present disclosure. FIG. 6 illustrates a plurality of data centers 610₁, 610₂, . . . , 610ₙ and a torrent server 620, where the plurality of data centers 610₁, 610₂, . . . , 610ₙ are distant from one another. In a scenario such as data encryption and scientific computation, for example, the data center 610₁ may become a main data center to assign a distributed task to other accessible data centers (e.g., the data centers 610₂, 610₃, and 610₄). In some embodiments of the present disclosure, the main data center 610₁ may push (S601) a task to the torrent server 620. Other data centers with a computational capability (e.g., the data centers 610₂, 610₃ and 610₄) may obtain the corresponding task via the torrent server 620 and execute the task. After the corresponding task is completed, these data centers (e.g., the data centers 610₂, 610₃ and 610₄) may transmit respective results to the main data center 610₁ (S603). The main data center 610₁ may aggregate all of the results to obtain a final computational result (S604).

In addition, the embodiments of the present disclosure may also be applied to a scenario of data aggregation. For example, a plurality of small satellite data centers may exist at different positions to serve different users, respectively. Additionally, there may also exist a central data center that holds all of the complete data. The satellite data centers may periodically transmit data to the central data center with the P2P data movement mechanism according to embodiments of the present disclosure, for analysis and/or archiving. Therefore, the data aggregation among distributed data centers can be implemented with the embodiments of the present disclosure.

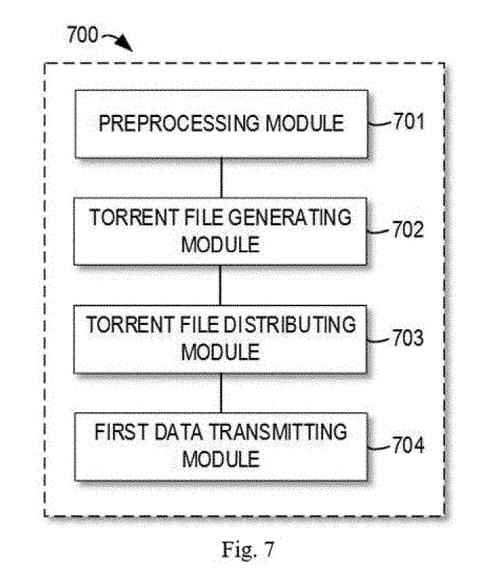

FIG. 7 illustrates a block diagram of an apparatus 700 for data movement among distributed data centers according to embodiments of the present disclosure. As illustrated in FIG. 7, the apparatus 700 may comprise: a pre-processing module 701 configured to reduce an amount of data to be moved by pre-processing the data; a torrent file generating module 702 configured to generate a torrent file for the data; a torrent file distributing module 703 configured to distribute the torrent file to a peer data center; and a first data transmitting module 704 configured to, in response to receiving a data request from the peer data center, transmit a segment of the data to the peer data center.

In some embodiments, the pre-processing module 701 may be further configured to de-duplicate and compress the data.

In some embodiments, the torrent file generating module 702 may be further configured to: segment the data into a plurality of segments of an equal length, the segment being included in the plurality of segments; determine a hash value for the segment; and write an index and the hash value for the segment into the torrent file.

In some embodiments, the torrent file may include configuration information related to the data, and the torrent file generating module 702 is further configured to: generate the configuration information related to the data; and write the configuration information into the torrent file. Specifically, the generating the configuration information related to the data may comprise: determining one or more candidates for the configuration information; determining a cost for each of the one or more candidates; and selecting, from the one or more candidates, a candidate with the lowest cost as the configuration information related to the data.

In some embodiments, the torrent file distributing module 703 may be further configured to: distribute the torrent file to the peer data center via a torrent server with a reliable network protocol.

In some embodiments, the data may include a file, and the first data transmitting module 704 may be further configured to: segment the file into a plurality of segments of an equal length, the segment being included in the plurality of segments; and transmit the segment of the file to the peer data center.

In some embodiments, the data may include a data block, and the first data transmitting module 704 may be further configured to: transmit the data block to the peer data center.

In some embodiments, the data may comprise an object, and wherein the first data transmitting module 704 may be further configured to: transmit the object to the peer data center.

For the sake of clarity, FIG. 7 does not show some optional modules of the apparatus 700. However, it should be understood that various features described above with reference to FIGS. 1-6 are likewise applicable to the apparatus 700. Moreover, respective modules of the apparatus 700 may be either hardware modules or software modules. For example, in some embodiments, the apparatus 700 may be implemented partially or completely by software and/or firmware, e.g., implemented as a computer program product embodied on a computer readable medium. Alternatively or additionally, the apparatus 700 may be implemented partially or completely based on hardware, e.g., implemented as an integrated circuit (IC), an application-specific integrated circuit (ASIC), a system on chip (SoC), a field programmable gate array (FPGA), etc. The scope of the present disclosure is not limited in this aspect.

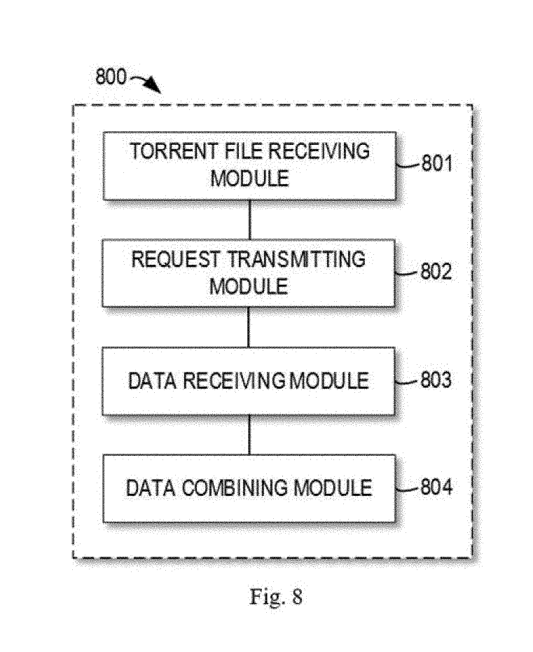

FIG. 8 illustrates a block diagram of an apparatus 800 for data movement among distributed data centers according to embodiments of the present disclosure. As illustrated in FIG. 8, the apparatus may comprise: a torrent file receiving module 801 configured to receive a torrent file from a source data center; a request transmitting module 802 configured to transmit a first data request for a segment of data associated with the torrent file to a first peer data center connected to the source data center; a data receiving module 803 configured to receive the segment of the data from the first peer data center, and a data combining module 804 configured to, in response to receiving a plurality of segments of the data, combine the plurality of segments into the data, the segment being included in the plurality of segments.

In some embodiments, the data receiving module 803 may be further configured to: receive the torrent file from the source data center via a torrent server with a reliable network protocol.

In some embodiments, the first peer data center includes the source data center.

In some embodiments, the torrent file may include configuration information related to the data, and the request transmitting module 803 may be further configured to: transmit the first data request for the data to the first peer data center based on the configuration information.

In some embodiments, the data receiving module 803 may be further configured to: in response to receiving the segment of the data, determine a first hash value of the segment; compare a first hash value with a second hash value corresponding to the segment, the second hash value being included in the torrent file; save the segment in response to the first hash value being equal to the second hash value; and transmit a second data request for the segment to a second peer data center in response to the first hash value being unequal to the second hash value.

In some embodiments, the data may include a file, and the data receiving module 803 may be further configured to: receive the segment of the file from the first peer data center. The data combining module 804 may be further configured to: in response to receiving a plurality of segments of the file, obtain the file by sequentially concatenating the plurality of segments of the file.

In some embodiments, the data may include a data block, and the data receiving module 803 may be further configured to: receive the data block from the first peer data center. The data combining module 804 may be further configured to: in response to receiving the first data block, write content of the first data block back into a second data block corresponding to the first data block.

In some embodiments, the data may include an object, and the data receiving module 803 may be further configured to: receive the object from the first peer data center.

In some embodiments, the apparatus 800 may further comprise: a network connection module configured to, in response to disconnection from the first peer data center, establish a connection with a third peer data center so as to transmit a third data request for the data to the third peer data center.

In some embodiments, the apparatus 800 may also comprise: a second data transmitting module configured to, in response to a fourth data request from a fourth peer data center, transmit the segment of the data to the fourth peer data center.

For the sake of clarity, FIG. 8 does not show some optional modules of the apparatus 800. However, it should be understood that various features described above with reference to FIGS. 1-6 are likewise applicable to the apparatus 800. Moreover, respective modules of the apparatus 800 may be either hardware modules or software modules. For example, in some embodiments, the apparatus 800 may be implemented partially or completely by software and/or firmware, e.g., implemented as a computer program product embodied on a computer readable medium. Alternatively or additionally, the apparatus 800 may be implemented partially or completely based on hardware, e.g., implemented as an integrated circuit (IC), an application-specific integrated circuit (ASIC), a system on chip (SoC), a field programmable gate array (FPGA), etc. The scope of the present disclosure is not limited in this aspect.

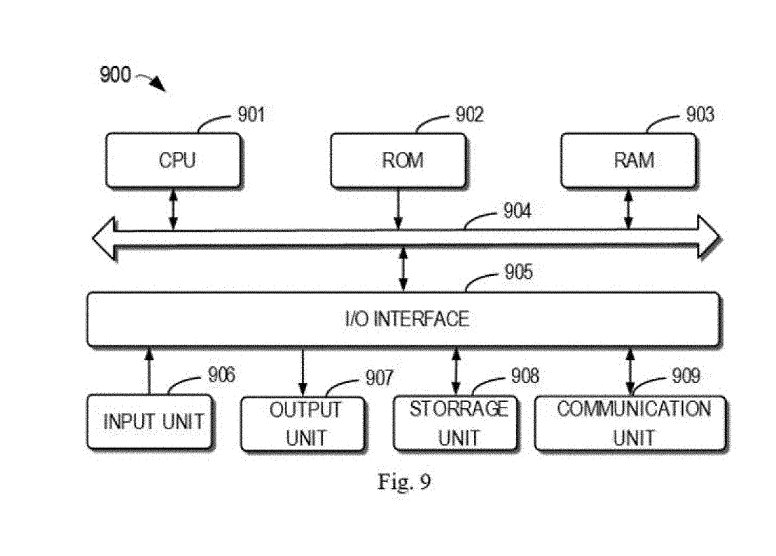

Hereinafter refer to FIG. 9, in which a block diagram of a device 900 adapted to implementing embodiments of the present disclosure is presented. As shown in FIG. 9, the device 900 comprises a central processing unit (CPU) 901 that may perform various appropriate actions and processing based on computer program instructions stored in a read-only memory (ROM) 902 or computer program instructions loaded from a storage section 908 to a random access memory (RAM) 903. In the RAM 903, there further store various programs and data needed for operations of the device 900. The CPU 901, ROM 902 and RAM 903 are connected to each other via a bus 904. An input/output (I/O) interface 905 is also connected to the bus 904.

The following components in the device 900 are connected to the I/O interface 905: an input 906 such as a keyboard, a mouse and the like; an output unit 907 including various kinds of displays and a loudspeaker, etc.; a memory unit 908 including a magnetic disk, an optical disk, and etc.; a communication unit 909 including a network card, a modem, and a wireless communication transceiver, etc. The communication unit 909 allows the device 900 to exchange information/data with other devices through a computer network such as the Internet and/or various kinds of telecommunications networks.

Various processes and processing described above, e.g., at least one of method 200, method 300, and method 400, may be executed by the processing unit 901. For example, in some embodiments, at least one of the method 200, method 300, and method 400 may be implemented as a computer software program that is tangibly embodied on a machine readable medium, e.g., the storage unit 908. In some embodiments, part or all of the computer programs may be loaded and/or mounted onto the device 900 via ROM 902 and/or communication unit 909. When the computer program is loaded to the RAM 903 and executed by the CPU 901, one or more steps of the at least one of the method 200, method 300, and method 400 as described above may be executed.

In view of the above, embodiments of the present disclosure provide a method and apparatus for data movement among distributed data centers. Compared with the prior art, the embodiments of the present disclosure can realize reliable and fast data movement among distributed data centers over an unreliable and low-bandwidth network, can support an adaptive network topology among distributed data centers without complex pre-configuration or cumbersome runtime coordination, can support different types of data storage, and facilitates coordinated cloud computing and data aggregation among distributed data centers.

Generally, various exemplary embodiments of the present disclosure may be implemented in hardware or specific circuits, software, logic, or any combination thereof. Some aspects may be implemented in hardware, while other aspects may be implemented in firmware or software that may be executed by a controller, a microprocessor or other computing device. When various aspects of the embodiments of the present disclosure are illustrated or described as block diagrams, flowcharts or represented by some other diagrams, it should be understood that the blocks, apparatuses, systems, technologies or methods described here may be implemented as non-limitative examples on hardware, software, firmware, specific circuit or logic, general hardware or controller or other computing device or some combinations thereof.

Moreover, various blocks in the flowcharts may be regarded as method steps, and/or operations generated by execution of the computer program codes, and/or understood as a plurality of coupled logic circuit elements executing relevant functions. For example, the embodiments of the present disclosure include a computer program product that includes a computer program tangibly embodied on the machine readable medium, the computer program including program codes configured to execute the methods described above.

In the context of the present disclosure, the machine-readable medium may be any tangible medium including or storing programs for or related to an instruction executing system, apparatus, or device. The machine readable medium may be a computer readable signal medium or a machine readable storage medium. The machine readable medium may include, but not limited to, an electronic, magnetic, optical, electromagnetic, infrared or semiconductor system, apparatus or device, or any appropriate combination thereof. More detailed examples of the machine readable storage medium comprise an electric connection with one or more wires, a portable computer magnetic disk, s hard disk, a random access memory (RAM), a read-only memory (ROM), an erasable programmable read-only memory (EPROM or flash memory), an optical storage device, a magnetic storage device, or any appropriate combination thereof.

The computer program codes for implementing the methods of the present disclosure may be compiled using one or more programming languages. These computer program codes may be provided to a processor of a general computer, a specific computer, or other programmable data processing device, such that the program codes, when being executed by the computer or other programmable data processing devices, cause the functions/operations prescribed in the flowcharts and/or block diagrams to be executed. The program codes may be executed completely on the computer, partially on the computer, as an independent software package, partially on the computer while partially on the remote computer, or completely on a remote computer or server.

In addition, although the operations are depicted in a specific sequence, it should not be understood to require such operations to be performed in the specific sequence as shown or in a successive order, or all of the shown operations to be executed, so as to obtain a desired result. In some circumstances, multi-task or parallel processing will be beneficial. Likewise, although the discussion above includes some specific implementation details, it should not be construed as limiting the scope of any invention or claims, but should be construed as a depiction of a specific embodiment of the specific invention. Some features described in contexts of separate embodiments in the present specification may also be integrally implemented in a single embodiment. On the contrary, various features described in the context of a single embodiment may also be separately implemented in a plurality of embodiments in any appropriate sub-combination of embodiments.

Various modifications and changes to the exemplary embodiments of the present disclosure as described above will become apparent to those skilled in the art in a relevant technical field when viewing the above depictions in conjunction with the accompanying drawings. Any and all modifications still fall within the scope of exemplary embodiments that are non-limitative. In addition, the above description and drawings have heuristic benefits, and those skilled in the art associated with these embodiments of the present disclosure will envisage other embodiments of the present disclosure explained here.

It will be understood that embodiments of the present disclosure are not limited to the specific embodiments as disclosed here, and modifications as well as other embodiments should be all included within the scope of the appended claims. Although specific terms are used here, they are only used in general and descriptive senses, not for limiting intentions.

1. A method for data movement among distributed data centers in a peer network, comprising:
reducing an amount of data to be moved by pre-processing the data;
generating a torrent file for the data;
distributing the torrent file to a peer data center; and
in response to receiving a data request from the peer data center, transmitting a segment of the data to the peer data center.

2. The method according to claim 1, wherein the pre-processing the data comprises:
de-duplicating and compressing the data.

3. The method according to claim 1, wherein the generating a torrent file for the data comprises:
segmenting the data into a plurality of segments of an equal length, the segment being included in the plurality of segments;
determining a hash value for the segment; and
writing an index and the hash value for the segment into the torrent file.

4. The method according to claim 1, wherein the torrent file includes configuration information related to the data, and the generating a torrent file for the data comprises:
generating the configuration information related to the data; and
writing the configuration information into the torrent file.

5. The method according to claim 4, wherein the generating the configuration information related to the data comprises:
determining one or more candidates for the configuration information;
determining a cost for each of the one or more candidates; and
selecting, from the one or more candidates, a candidate with the lowest cost as the configuration information related to the data.

6. The method according to claim 1, wherein the distributing the torrent file to a peer data center comprises:
distributing the torrent file to the peer data center via a torrent server with a reliable network protocol.

7. The method according to claim 1, wherein the data includes a file, and the transmitting a segment of the data to the peer data center comprises:
segmenting the file into a plurality of segments of an equal length, the segment being included in the plurality of segments; and
transmitting the segment of the file to the peer data center.

8. The method according to claim 1, wherein the data includes a data block, and the transmitting a segment of the data to the peer data center comprises:
transmitting the data block to the peer data center.

9. The method according to claim 1, wherein the data includes an object, and the transmitting a segment of the data to the peer data center comprises:
transmitting the object to the peer data center.

10-42. (canceled)

43. A system, comprising:
two or more of distributed data centers, wherein each distributed data center includes one or more data storage systems; and
computer-executable program logic in memory of one or more computers enabled to move data among the distributed data centers in a peer network, wherein the computer-executable program logic is configured for the execution of:
reducing an amount of data to be moved by pre-processing the data;
generating a torrent file for the data;
distributing the torrent file to a peer data center; and
in response to receiving a data request from the peer data center, transmitting a segment of the data to the peer data center.

44. The system according to claim 43, wherein pre-processing of the data comprises:
de-duplicating and compressing the data.

45. The system according to claim 43, wherein the generating a torrent file for the data comprises:
segmenting the data into a plurality of segments of an equal length, the segment being included in the plurality of segments;
determining a hash value for the segment; and
writing an index and the hash value for the segment into the torrent file.

46. The system according to claim 43, wherein the torrent file includes configuration information related to the data, and the generating a torrent file for the data comprises:
generating the configuration information related to the data; and
writing the configuration information into the torrent file.

47. The system according to claim 46, wherein the generating the configuration information related to the data comprises:
determining one or more candidates for the configuration information;
determining a cost for each of the one or more candidates; and
selecting, from the one or more candidates, a candidate with the lowest cost as the configuration information related to the data.

48. A computer program product for moving data among distributed data centers in a peer network, wherein each of the distributed data centers includes one or more data storage systems, the computer program product comprising:
a non-transitory computer readable medium encoded with computer-executable code, the code configured to enable the execution of:
reducing an amount of data to be moved by pre-processing the data;
generating a torrent file for the data;
distributing the torrent file to a peer data center; and
in response to receiving a data request from the peer data center, transmitting a segment of the data to the peer data center.

49. The computer program product according to claim 48, wherein pre-processing of the data comprises:
de-duplicating and compressing the data.

50. The computer program product according to claim 48, wherein the generating a torrent file for the data comprises:
segmenting the data into a plurality of segments of an equal length, the segment being included in the plurality of segments;
determining a hash value for the segment; and
writing an index and the hash value for the segment into the torrent file.

51. The computer program product according to claim 48, wherein the torrent file includes configuration information related to the data, and the generating a torrent file for the data comprises:
generating the configuration information related to the data; and
writing the configuration information into the torrent file.

52. The computer program product according to claim 51, wherein the generating the configuration information related to the data comprises:
determining one or more candidates for the configuration information;
determining a cost for each of the one or more candidates; and
selecting, from the one or more candidates, a candidate with the lowest cost as the configuration information related to the data.
